(19) United States
(12) Patent Application Publication
(10) Pub. No.: US 2013/0135356 A1
(43) Pub. Date: May 30, 2013

(54) APPARATUS AND METHOD FOR DISPLAYING DATA ITEMS IN A WIRELESS TERMINAL

(71) Applicant: Samsung Electronics Co., Ltd, Gyeonggi-do (KR)

(72) Inventor: Sang-Min Shin, Gyeonggi-do (KR)

(73) Assignee: Samsung Electronics Co., Ltd, Gyeonggi-do (KR)

(21) Appl. No.: 13/687,975

(22) Filed: Nov. 28, 2012

(30) Foreign Application Priority Data
Nov. 28, 2011 (CN) 10-2011-0125447

(51) Int. Cl. G06F 3/0485

(52) U.S. Cl. CPC G06F 3/0485
USPC 345/684

(57) ABSTRACT

According to one embodiment, a displaying data items in a wireless terminal apparatus includes a display unit configured to display a specified region next to the last data item when the last data item is displayed at a specified position; and a controller configured to control the display unit to display the specified region next to the last data item when the last data item arrives at the specified position according to scrolling of a plurality of data items in a specified direction.

### CROSS-REFERENCE TO RELATED APPLICATION(S) AND CLAIM OF PRIORITY

The present application is related to and claims priority under 35 U.S.C. §119(a) to a Korean Patent Application filed in the Korean Intellectual Property Office on Nov. 28, 2011 and assigned Serial No. 10-2011-0125447, the contents of which are incorporated herein by reference.

### TECHNICAL FIELD OF THE INVENTION

The present invention generally relates to telecommunication devices, and more particularly, to an apparatus and method for displaying data items in a wireless terminal.

### BACKGROUND OF THE INVENTION

A wireless terminal is a type of communication device in which an individual may wirelessly access and communicate with other individuals, carrying it with him or her, while on the move in the coverage of a particular mobile communication system to which he or she has subscribed.

The wireless terminal provides not only communication services but also various value-added services such as online gaming, image capturing, and messaging, and storage of a relatively large amount of diverse data that may be stored in the wireless terminal due to these value-added services.

When the wireless terminal displays data items such as photos stored in a memory, phone numbers stored in a phone book, and call information stored in a last call list, its user may scroll up and down the data items to see all of the data items which may not necessarily be displayed on a single screen.

However, upon arrival at the last data item while scrolling the non-displayed data items, the user typically perceives the arrival at the last data item only when the data items are no longer scrolled.

### SUMMARY OF THE INVENTION

To address the above-discussed deficiencies of the prior art, it is a primary object to provide an apparatus and method for displaying data items in a wireless terminal.

According to one embodiment of the present invention, an apparatus configured to display data items in a wireless terminal includes a display unit configured to display a specified region next to the last data item when the last data item is displayed at a specified position; and a controller configured to control the display unit to display the specified region next to the last data item when the last data item arrives at the specified position according to scrolling of a plurality of data items in a specified direction.

According to another embodiment of the present invention, a method of displaying data items in a wireless terminal includes displaying a plurality of data items, and when the last data item arrives at a specified position when scrolling of the plurality of data items in a specified direction, displaying a specified region next to the last data item.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless terminal according to an embodiment of the present invention;

FIG. 2 illustrates an example process of displaying data items in the wireless terminal, according to an embodiment of the present invention; and

FIGS. 3A to 3C illustrate example screens for describing the process of FIG. 2.

### DETAILED DESCRIPTION OF THE INVENTION

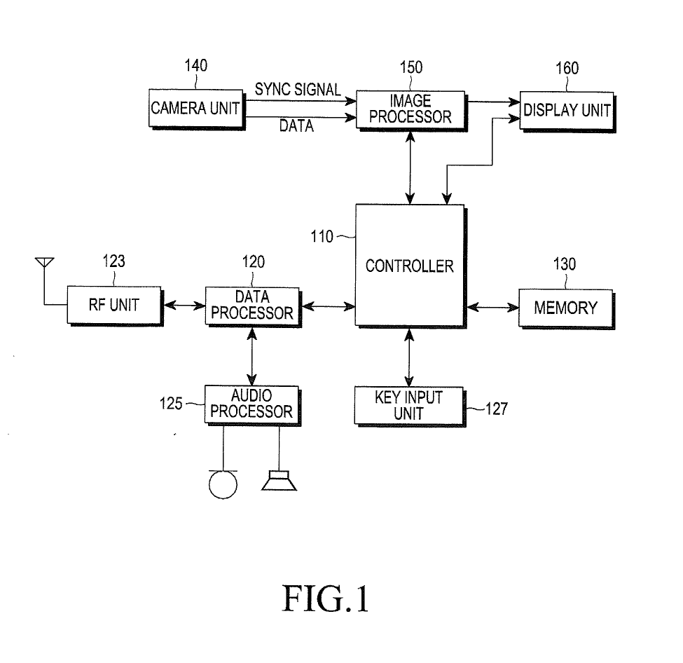

FIGS. 1 through 3C, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless devices. Preferred embodiments of the present invention will be described herein below with reference to the accompanying drawings. Like reference numbers are used to refer to like elements through at the drawings.

FIG. 1 illustrates an example wireless terminal according to an embodiment of the present invention.

Referring to FIG. 1, a Radio Frequency (RF) unit 123 performs a wireless communication function of the wireless terminal. The RF unit 123 includes an RF transmitter for up-converting a frequency of a transmission signal and amplifying the up-converted transmission signal and an RF receiver for low-noise amplifying a received signal and down-converting a frequency of the amplified received signal. A data processor 120 includes a transmitter for coding and modulating the transmission signal and a receiver for demodulating and decoding the received signal. In other words, the data processor 120 may include such devices as a modem and/or a codec. The codec includes a data codec for processing packet data and the like, and/or an audio codec for processing audio signals such as voice. An audio processor 125 processes received audio signals outputted from the audio codec in the data processor 120 and transfers transmission audio signals picked up by a microphone to the audio codec in the data processor 120.

A key input unit 127 includes alphanumeric keys for inputting alphanumeric information and one or more function keys for setting various functions.

A memory 130 may include a program memory and a data memory. The program memory may store programs for controlling a general operation of the wireless terminal. In addition, the program memory may store programs for controlling a display unit 160 to display the last data item to be distinguished from the others when displaying a plurality of data items through scrolling.

In addition, the data memory may temporarily store data generated while the programs are executed.

A controller 110 controls the overall operation of the wireless terminal.

According to an embodiment of the present invention, the controller 110 controls the display unit 160 to stop scrolling and display a specified region next to the last data item when the last data item arrives at a specified position while scrolling of a plurality of data items in a specified direction is performed. The specified direction includes any one of a direction from the top to the bottom, a direction from the bottom to the top, a direction from the left to the right, and a direction from the right to the left.

In addition, the specified region displayed next to the last data item is a region for informing a user that the last data item arrives at the specified position and may include at least one of a space, a graphic effect, and a picture. In addition, when the specified region for informing the user that the last data item arrives at the specified position is displayed, a specific alarm sound may be outputted, or a vibration may be generated. In addition, the specified region may be a region from an area next to the last data item to the bottom of a screen of the display unit 160.

In addition, the specified position may include any portion of the screen of the display unit 160, a one-third position of the screen, and a specific position which can be displayed together with the specified region.

In addition, when a specified data item close to the last data item is displayed while scrolling the plurality of data items in the specified direction, the controller 110 controls the display unit 160 to gradually decrease a scrolling speed of displayed data items. The specified data item close to the last data item may include a data item displayed before the last data item is displayed. For example, when a data item displayed previously by five data items prior to the last data item is set as the specified data item close to the last data item, the controller 110 may control the display unit 160 to gradually decrease a scrolling speed of displayed data items, and when the last data item arrives at the specified position, stop the scrolling.

In addition, when scrolling in the same direction as the specified direction is performed again when the last data item is displayed at the specified position, the controller 110 controls the display unit 160 to display data items starting from the first data item again by scrolling data items including the last data item and the specified region displayed on the screen in the same direction.

In addition, when a displayed area of the specified region is decreased by displaying the data items starting from the first data item again due to the scrolling in the same direction as the specified direction, the controller 110 controls the display unit 160 to gradually increase a scrolling speed of data items according to the decrease of the displayed area of the specified region.

In addition, when the specified region is not displayed on the screen of the display unit 160 anymore, the controller 110 controls the display unit 160 to return the scrolling speed of data items to an original scrolling speed of data items.

A camera unit 140 includes a camera sensor for capturing image data and converting the captured imagery into electrical signals, and a signal processor for converting analog image signals captured by the camera sensor into digital data. The camera sensor is assumed herein to be a Charge-Coupled Device (CCD) or Complementary Metal Oxide Semiconductor (CMOS) sensor, and the signal processor may be realized by a Digital Signal Processor (DSP). The camera sensor and the signal processor may be realized in an integrated manner or in a discrete manner.

An image processor 150 performs Image Signal Processing (ISP) for displaying image signals output from the camera unit 140 on the display unit 160, and the ISP may perform other functions such as gamma correction, interpolation, spatial variation, image effects, image scaling, Automatic White Balance (AWB), Automatic Exposure (AE), and Automatic Focusing (AF). The image processor 150 processes the image signals outputted from the camera unit 140 on a frame basis, and outputs the frame-based image data according to the characteristics and size of the display unit 160. The image processor 150, which includes a video codec, compresses frame image data displayed on the display unit 160 by preset coding, and restores (or decompresses) the compressed frame image data into its original frame image data. The video codec may include a JPEG codec, MPEG4 codec, Wavelet codec, etc. Assuming that the image processor 150 includes an On-Screen Display (OSD) function, the controller 110 may control the image processor 150 to output OSD data according to the size of a screen on which the data is displayed.

The display unit 160 displays images outputted from the image processor 150 and user data outputted from the controller 110 on a screen. The display unit 160 may include a Liquid Crystal Display (LCD), and in this case, the display unit 160 includes an LCD controller, a memory for storing image data, and an LCD panel. The LCD may serve as an input unit with a touch screen, and in this case, the display unit 160 may display the alphanumeric keys of the key input unit 127.

In addition, according to an embodiment of the present invention, the display unit 160 displays the specified region next to the last data item when the last data item is displayed at the specified position according to scrolling of the plurality of data items in the specified direction.

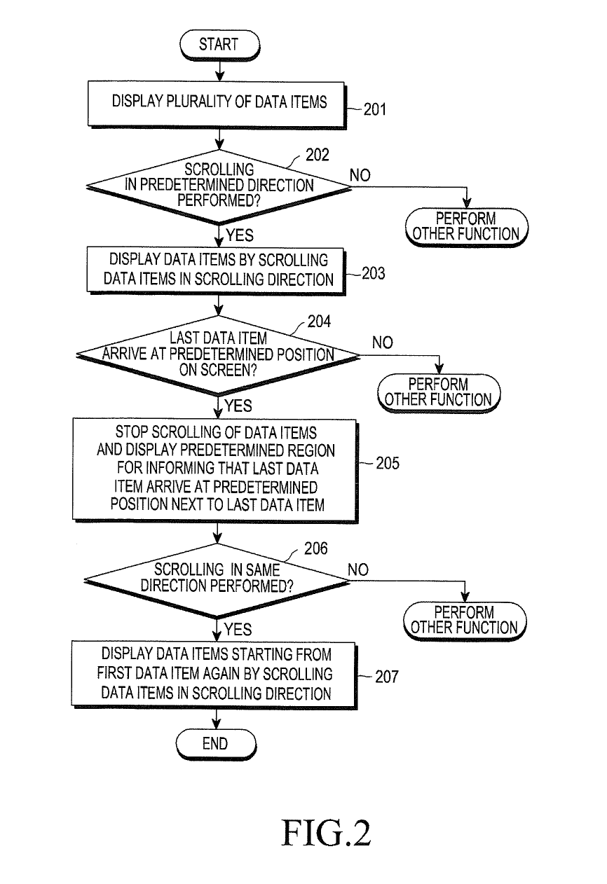

An operation of displaying data items in the wireless terminal described above is described in detail with reference to FIG. 2.

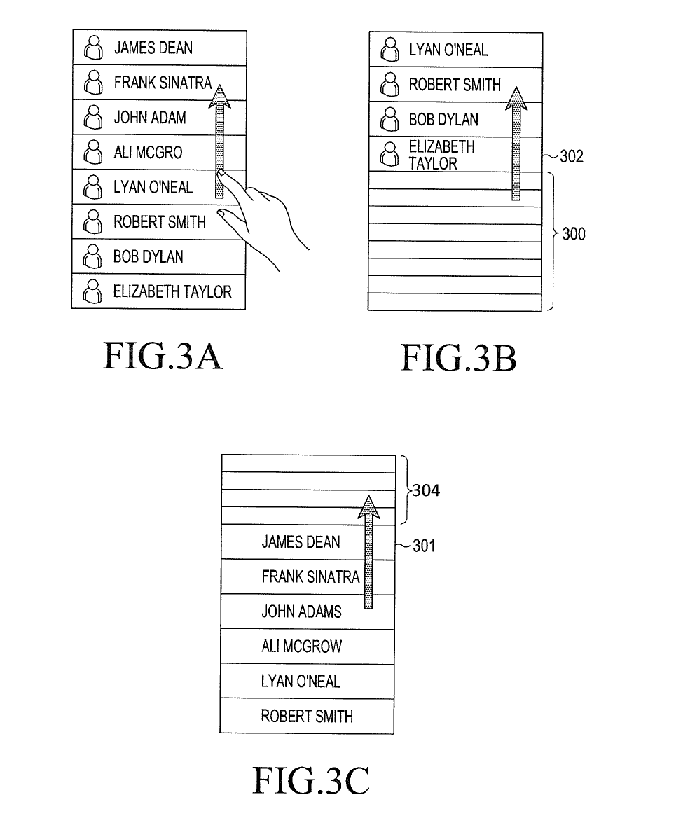

FIG. 2 illustrates an example process of displaying data items in the wireless terminal, according to an embodiment of the present invention. Additionally, FIGS. 3A to 3C are illustrative diagrams for describing the process of FIG. 2.

Hereinafter, this embodiment is described in detail with reference to FIG. 1.

Referring to FIG. 2, in step 201 in which a plurality of data items are displayed on the screen of the display unit 160, when scrolling in the specified direction is performed, the controller 110 detects this in step 202 and proceeds to step 203 to display data items by scrolling the data items at a specified scrolling speed in a scrolling direction.

According to continuous scrolling, when a specified data item close to the last data item is displayed while data items are scrolled and displayed on the screen of the display unit 160, the controller 110 controls the display unit 160 to gradually decrease a scrolling speed of displayed data items.

If the last data item arrives at a specified position on the screen of the display unit 160 while the scrolling speed of displayed data items is gradually decreased, the controller 110 detects this in step 204 and proceeds to step 205 to stop the scrolling and inform the user that the last data item arrives at the specified position by displaying the specified region next to the last data item.

If scrolling in the same direction as the specified direction is performed again while the last data item and the specified region are displayed on the screen of the display unit 160, the controller 110 detects this in step 206 and proceeds to step 207 to display data items starting from the first data item again by scrolling data items including the last data item and the specified region displayed on the screen in the same direction.

If a displayed area of the specified region is decreased by scrolling the data items including the last data item and the specified region in the same direction as the specified direction in step 207, the controller 110 controls the display unit 160 to increase a scrolling speed of data items according to the decrease of the displayed area of the specified region. Therefore, when the first data item is displayed on the top of the screen without viewing the specified region due to continuous scrolling, the controller 110 controls the display unit 160 to return the scrolling speed of data items to an original scrolling speed of data items.

FIGS. 3A to 3C illustrate example display screens for describing the process of FIG. 2. These particular display screens show data items of a phonebook as an example.

As shown in FIG. 3A, when scrolling is performed in a direction from the bottom to the top while a plurality of data items stored in the phonebook are displayed, the controller 110 displays data items by scrolling the data items at a scrolling speed of data items. As shown in FIG. 3B, when the last data item 302 arrives at a specified position due to continuous scrolling, the controller 110 stops the scrolling of data items and display a space 300, which is a specified region for informing the user that the last data item 302 has arrived at the specified position, next to the last data item 302. When scrolling is performed again in the direction from the bottom to the top in FIG. 3B, the controller 110 scrolls data items including the last data item 302 and the space 300 that is the specified region in the direction from the bottom to the top, and accordingly, displays data items starting from the first data item 301 while decreasing the space 300 that is the specified region as shown in FIG. 3C.

As is apparent from the foregoing description, the proposed apparatus and method for displaying data items in a wireless terminal can increase convenience of a user when data items are displayed through scrolling.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. An apparatus configured to display a plurality of data items in a wireless terminal, the apparatus comprising:
a display unit configured to display a specified region next to a last of the plurality of data items when the last data item is displayed at a specified position; and
a controller configured to control the display unit to display the predetermined region next to the last data item when the last data item arrives at the specified position according to scrolling of the plurality of data items in a specified direction.

2. The apparatus of claim 1, wherein, when a specified data item close to the last data item is displayed while scrolling the plurality of data items in the specified direction, the controller is configured to control the display unit to gradually decrease a scrolling speed of displayed data items.

3. The apparatus of claim 1, wherein, when the last data item arrives at the specified position due to the scrolling, the controller is configured to control the display unit to stop the scrolling of data items.

4. The apparatus of claim 1, wherein, when scrolling in the same direction as the specified direction is performed again when the last data item is displayed at the specified position, the controller is configured to control the display unit to display data items starting from the first data item again by scrolling data items including the last data item and the specified region displayed on the screen in the same direction.

5. The apparatus of claim 4, wherein, when a displayed area of the specified region is decreased by displaying the data items starting from the first data item again, the controller is configured to control the display unit to gradually increase a scrolling speed of data items according to the decrease of the displayed area of the specified region.

6. The apparatus of claim 1, wherein the specified region comprises a region configured to inform that the last data item arrives at the specified position.

7. The apparatus of claim 1, wherein the specified region includes at least one of a space, a graphic effect, and a picture.

8. A method of displaying data items in a wireless terminal, the method comprising:
displaying a plurality of data items; and
when the last data item arrives at a specified position when scrolling of the plurality of data items in a specified direction, displaying a specified region next to the last data item.

9. The method of claim 8, wherein the displaying of the specified region comprises, when the last data item arrives at the specified position due to the scrolling, stopping the scrolling of data items.

10. The method of claim 8, wherein the displaying of the specified region comprises, when a specified data item close to the last data item is displayed while scrolling of the plurality of data items in the specified direction, gradually decreasing a scrolling speed of displayed data items.

11. The method of claim 8, further comprising, when scrolling in the same direction as the specified direction is performed when the last data item is displayed at the specified position, displaying data items starting from the first data item again by scrolling data items including the last data item and the specified region in the same direction.

12. The method of claim 11, wherein the displaying of the data items starting from the first data item again comprises, when a displayed area of the specified region is decreased by displaying the data items starting from the first data item again, gradually increasing a scrolling speed of data items according to the decrease of the displayed area of the specified region.

13. The method of claim 8, wherein the specified region comprises a region for distinguishing the last data item from the first data item.

14. The method of claim 8, wherein the specified region includes at least one of a space, a graphic effect, and a picture.

15. A non-transitory computer readable medium embodying a computer program, the computer program comprising computer readable program code for:
displaying a plurality of data items; and
when the last data item arrives at a specified position when scrolling of the plurality of data items in a specified direction, displaying a specified region next to the last data item.

16. The code of claim 15, wherein the displaying of the specified region comprises, when the last data item arrives at the specified position due to the scrolling, stopping the scrolling of data items.

17. The code of claim 15, wherein the displaying of the specified region comprises, when a specified data item close to the last data item is displayed while scrolling of the plurality of data items in the specified direction, gradually decreasing a scrolling speed of displayed data items.

18. The code of claim 15, further comprising, when scrolling in the same direction as the specified direction is performed when the last data item is displayed at the specified position, displaying data items starting from the first data item again by scrolling data items including the last data item and the specified region in the same direction.

19. The code of claim 18, wherein the displaying of the data items starting from the first data item again comprises, when a displayed area of the specified region is decreased by displaying the data items starting from the first data item again, gradually increasing a scrolling speed of data items according to the decrease of the displayed area of the specified region.

20. The code of claim 15, wherein the specified region comprises a region for distinguishing the last data item from the first data item.
